(19) United States
(12) Patent Application Publication
(10) Pub. No.: US 2018/0150882 A1
(43) Pub. Date: May 31, 2018

(54) Systems and Methods for Use in Determining Consumer Interest in Products Based on Intensities of Facial Expressions

(71) Applicant: MASTERCARD INTERNATIONAL INCORPORATED, Purchase, NY (US)

(72) Inventors: Po Hu, Norwalk, CT (US); Shen Xi Meng, Millwood, NY (US); Jean-Pierre Gerard, Croton-On-Hudson, NY (US)

(21) Appl. No.: 15/361,791

(22) Filed: Nov. 28, 2016

(51) Int. Cl. G06Q 30/02; G06K 9/00

(52) U.S. Cl. CPC G06Q 30/0269; G06K 9/00302; G06Q 30/0255; G06Q 30/0261

(57) ABSTRACT

Exemplary systems and methods are provided for directing offer content to consumers at communication devices, while the consumers are at merchants. An exemplary method includes capturing an image of a consumer when the consumer is in the vicinity of a product at a merchant, where the image depicts a facial expression of the consumer, and determining an intensity associated with the facial expression of the consumer, as captured in the image. The method also includes determining, by a computing device, a location at the merchant of a communication device associated with the consumer and selecting, by the computing device, an offer associated with the product for the consumer, based on the intensity of the facial expression and the determined location of the communication device, thereby relying at least in part on a consumer reaction to select the offer.

### FIELD

The present disclosure generally relates to systems and methods for use in determining consumer interest in products, and in particular, for use in determining consumer interest in products based on intensities of facial expressions, as to particular emotional factors, for consumers when viewing and/or in the presence of the products.

### BACKGROUND

This section provides background information related to the present disclosure that is not necessarily prior art.

Products (e.g., goods, services, etc.) are known to be offered for sale, and to be sold, by merchants. Consumers are also known to purchase the products from the merchants. The consumers may purchase the products to fulfill needs for the products (e.g., groceries, etc.), or based on desires for the products. In any event, the consumers often have choices between different products, whereby sale of the products is one indicator of the consumers' like or dislike of the products, of the product costs, of advertising relating to the products, etc. Separately, manufacturers of products and/or merchants involved with offering the products for sale and selling the products are known to interact with consumers to elicit verbal and/or written feedback from the consumers regarding various ones of the products. The interactions with the consumers and the feedback provided by the consumers may, from time to time, lead to changes in the products offered for sale, in general or specifically, to certain consumers or groups of consumers.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in determining interest of consumers in products based on, at least in part, intensities of facial expressions of the consumers when in the vicinity and/or presence of the products;

FIG. 2 is a front elevation view of an exemplary installation of a camera at a display of a merchant;

FIG. 3 is a block diagram of a computing device that may be used in the exemplary system of FIG. 1;

FIG. 4 is a block diagram of an exemplary method, which may be used in connection with the system of FIG. 1, for determining interest of a consumer in a product based on intensity of a facial expression of the consumer when viewing and/or in the presence of the product; and

FIG. 5 is a block diagram of an exemplary installation of multiple cameras in a merchant, in association with multiple products offered for sale by the merchant.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Merchants and/or manufactures attempt to sell products to consumers, and further attempt to understand the likes and dislikes of consumers in connection with selecting products to be offered for sale. To do so, the merchants and/or manufactures often rely on historical purchase data for the products, related products, and, sometimes, unrelated products, as well as market research and surveys through which consumers provide feedback related to different products. As such, the merchants and/or manufactures are limited in the data upon which decisions related to product offerings may be based. Uniquely, the systems and methods herein are suited to determine consumer interest in products offered for sale at merchants based on facial expressions of consumers. In particular, for example, cameras are disposed at merchant locations to capture, with the consumer's consent, images of a consumer's face when the consumer is in the vicinity and/or presence of one or more particular products offered for sale by a merchant. The images are analyzed to determine an intensity of facial expressions of the consumer in the images (in connection with one or more emotional factors (e.g., likeness, surprise, confusion, focus, exhaustion, etc.). By merging the intensities derived from the images and a location of the consumer when the images are captured (determined based on a location of a communication device associated with the consumer, for example), an evaluation engine may determine whether the consumer is interested in the particular product(s) or not. The evaluation engine then may select one or more offers for the consumer for the product(s) in which the consumer's facial expressions reveal a “like” while omitting offers for the product(s) in which the consumer's facial expressions reveal a “dislike.” Apart from selecting the offer(s) for the consumer, the merged data and/or the facial expression intensity data may also be provided to entities involved in selecting the product(s) (or features of products) to be offered for sale, etc. (e.g., product manufacturers, etc.), whereby the consumer's various emotional responses may be factored into such decisions in an efficient and accurate manner.

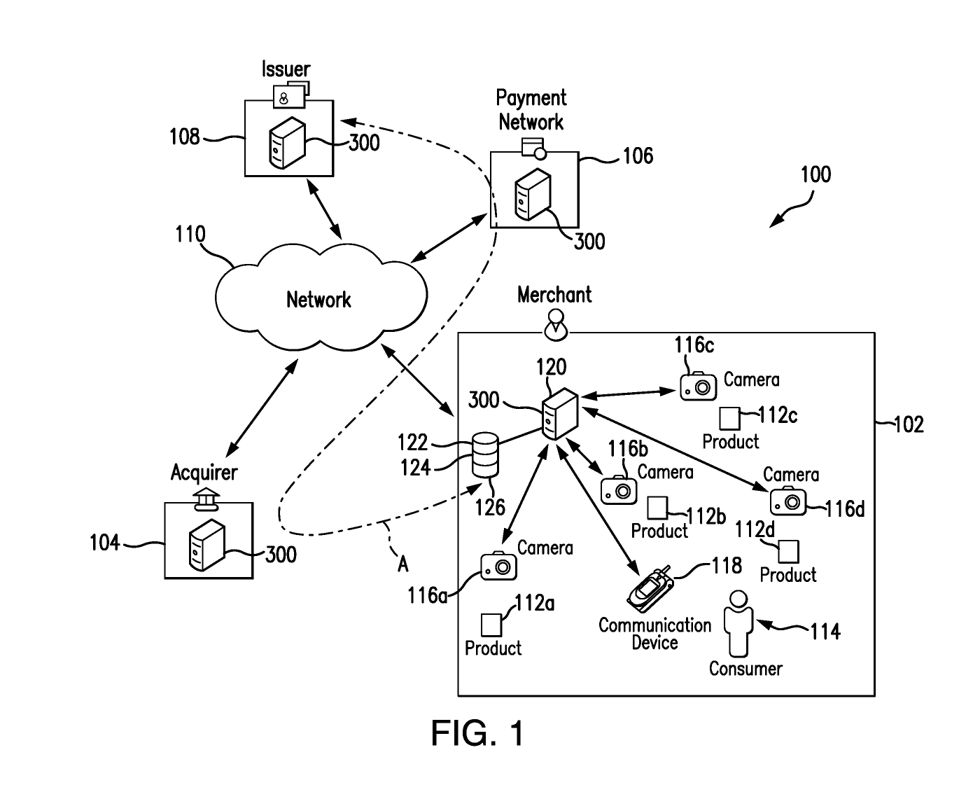

FIG. 1 illustrates an exemplary system 100, in which one or more aspects of the present disclosure may be implemented. Although, in the described embodiment, the system 100 is presented in one arrangement, other embodiments may include the system 100 arranged otherwise, depending, for example, on merchant locations and/or configurations, types of products offered for sale by merchants, manners of capturing consumer expressions, etc.

Referring to FIG. 1, the system 100 generally includes a merchant 102, an acquirer 104, a payment network 106, and an issuer 108, each coupled to (and in communication with) network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In this example, the network 110 may include a private payment transaction network made accessible by the payment network 106 to the acquirer 104 and the issuer 108 and, separately, a public network (e.g., the Internet, etc.) through which the merchant 102 and the acquirer 104 may communicate (e.g., via a website or via various network-based applications, etc.).

In the system 100, the merchant 102 offers a variety of products (e.g., goods and/or services, etc.) for sale. FIG. 1 illustrates four exemplary products as blocks, referenced 112a-d. The products may include any different products, for example, automobiles, books, electronics, power tools, home care items, toys, etc. The products 112a-d are often situated at the merchant 102, so that consumers are able to view the products 112a-d (and potentially interact with the products 112a-d (e.g., pick up, hold, feel, touch, interaction with, etc.)). However, in some instances, rather than the physical products 112a-d, the merchant 102 may include a presentation related to the products 112a-d offered for sale (e.g., images, summaries, demonstration, videos, advertising kiosks, etc.). Here, when consumers view the presentations related to the products 112a-d, the consumers should still be understood to be viewing and/or in the vicinity of the products 112a-d. For example, a consumer, such as exemplary consumer 114, viewing and/or holding a smartphone at the merchant 102 (i.e., in the vicinity of the physical smartphone) would be the same as the consumer 114 viewing a description of the smartphone including subscription fees for streaming services and/or images of the same smartphone, etc. (i.e., the consumer 114 would still be considered in the vicinity of the smartphone herein, even though not in the vicinity of the physical smartphone).

In addition in the system 100, multiple cameras 116a-d are disposed at the merchant 102. Each of the cameras 116a-d is generally assigned to a region of the merchant 102 and/or to one or more of the products 112a-d at the merchant 102. The cameras 116a-d are generally disposed to capture images of the consumers with their consent (e.g., the consumer 114, etc.) when in the presence and/or vicinity of the products 112a-d. In connection therewith, the cameras 116a-d may be, for example, suitable cameras to be mounted on shelves of the merchant 102, so that the cameras are installed at a height to capture images of consumers' faces. In particular, the cameras 116a-d may be disposed to capture images of the consumers while the consumers are interacting with and/or in the vicinity of the specific products 112a-d, but not other (or all) products at the merchant 102. Further, the cameras 116a-d may be configured to capture the images of the consumers and transmit image records associated therewith to a desired computing device. The image records may include the raw images captured by the cameras 116a-d, and/or analysis of the images as described in more detail below. In at least one embodiment, the camera 116c, for example, is configured to capture an image of a consumer viewing product 112c, to analyze the captured image, and to transmit the raw image (as captured) and an analysis thereof in an image record to a computing device, for example, all with the consumer's consent.

In one implementation of the system 100, the cameras 116a-d may each include micro cameras, being of sufficient size to operate as described herein, but small enough to reduce the impact on a product display and/or shelving at the merchant 102. For example, a micro camera may measure at about one inch square or less. However, cameras having other sizes, dimensions, and/or shapes (e.g., dimensions greater than one inch, etc.; shapes other than square; etc.) may be used in other implementations of the system 100. Further, cameras other than micro cameras may be used in various implementations of the system 100 (e.g., any camera suitable to capture facial expressions of consumers, etc.).

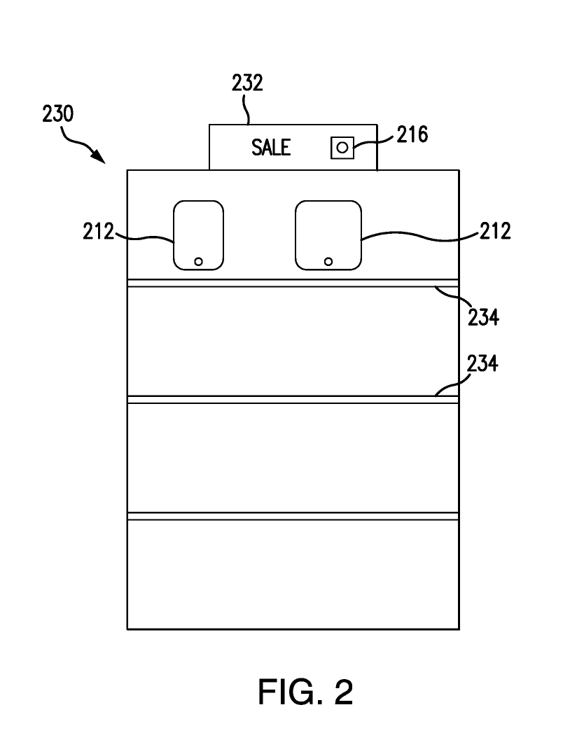

FIG. 2 illustrates an example installation of a camera 216 (e.g., a micro camera, etc.) at a merchant in accordance with the present disclosure. In this example, the camera 216 is installed at a display 230 associated with various products (each indicated at 212) offered for sale by the merchant. In particular, the camera 216 is disposed along an upper portion of the display 230 within a sign 232. In this position, the camera 216 is capable of capturing images of consumers' faces when viewing the products 212 (without impacting the product display 230 and/or shelving 234, and without interfering with consumers views of the products 212). In other embodiments, the camera 216 may be positioned differently in the display 230, for example, on one of the shelves 234, etc.

With reference again to FIG. 1, in an example interaction in the system 100, the consumer 114 is able to move within the merchant 102 to view and/or interact with the products 112a-d, which the consumer 114 may or may not decide to purchase (during a shopping session). In doing so, the consumer 114 establishes himself/herself in the vicinity of the products 112a-d, as the consumer 114 moves through the merchant 102. Being within the vicinity and/or presence of the products 112a-d may include, for example, the consumer 114 being within 5 meters, 2 meters, 1 meter, a half meter, or less, etc., of the products 112a-d, or in front of the products 112a-d within an aisle of the merchant 102, etc. In addition, being within the vicinity and/or presence of the products 112a-d may include, for example, the consumer 114 moving in a direction toward the products 112a-d, facing the products 112a-d, etc.

The consumer 114 is associated with a communication device 118, which may include, for example, a smartphone, a tablet, etc. The communication device 118 generally moves with the consumer 114, as the consumer 114 moves from location to location at/within the merchant 102, etc. The communication device 118, as shown, is coupled to and is in communication with the network 110.

In this exemplary embodiment, the consumer's communication device 118 is configured, via a network-based application (not shown) (e.g., installed on the communication device 118 or otherwise accessible by the communication device 118, etc.), to perform one or more of the operations described herein. Specifically, the communication device 118 is configured, via the application, to cooperate with the merchant 102 (and specifically, an evaluation engine 120 associated with the merchant 102 (described below)) to provide its location to the merchant 102 (which is generally understood to be an approximation and/or indication of the location of the consumer 114). In connection therewith, the communication device 118 may determine its location through GPS, or based on one or more network interactions (e.g., interactions with routers at the merchant 102, etc.), or by transmitting certain information from which the merchant 102 is able to determine the communication device's location. For example, router signals may be employed consistent with the description in Applicant's co-owned U.S. patent application Ser. Nos. 14/978,686, 14/978,706, and 14/978,735, each of which is incorporated herein by reference in its entirety. Additionally, the communication device 118 is also configured to transmit to the merchant 102 (and specifically, to the evaluation engine 120) an identifier (ID) for the communication device 118, such as, for example, a unique application ID (APP ID), a media access control (MAC) address, or other ID associated with and/or unique or at least partially unique to the communication device 118 and/or the consumer 114.

With that said, and as an example, the evaluation engine 120 may be configured to determine if the consumer 114 is within the vicinity and/or presence of one of the products 112a-d based on location data received from the consumer's communication device 118 combined with image data received from the cameras 116a-d. For example, the evaluation engine 120 may receive multiple location coordinates from the consumer's communication device 118 as a function of time, for example, XY(t), when the consumer enters the merchant 102. Based thereon, a current position of the consumer 114 at the merchant 102 can be estimated (based on location data received for the current time), as well as a distance of the consumer 114 from each of the products 112a-d in the merchant (based on location coordinates of the products 112a-d in the merchant 102). From the received location coordinates for the most recent times (e.g., the last five seconds, the last ten seconds, the last thirty seconds, the last minute, the last five minutes, etc.), a direction of consumer movement within the merchant 102 can be determined, for example, XY(t-1) . . . XY(t-k). Then, based on information received from the cameras 116a-d (e.g., face direction of the consumer 114, etc.), the particular one of the products 112a-d actually being viewed by the consumer 114 can be determined (as well as consumer interest in the particular one of the products, based on facial expressions, etc.). This will be described in more detail hereinafter.

With that said, reference to XY coordinates within the merchant 102 is generally based on a coordinate system or grid system defined by the merchant 102 at the merchant's location (with the coordinates (0, 0) generally representing where an X-axis and a Y-axis intersect, as overlaid on the merchant's location; etc.). However, it should be appreciated that other coordinate systems may be used herein without departing from the scope of the present disclosure, for example. Longitude and latitude coordinate systems, etc.

It should be appreciated that although only one merchant 102, one acquirer 104, one payment network 106, one issuer 108, one consumer 114, and one communication device 118 are illustrated in FIG. 1, other system embodiments, may, and often will, include a different number of one or more of these components. Further, the merchant 102 may, and likely will, offer more or fewer than the four different products 112a-d for sale, potentially causing more or fewer cameras 116a-d to be disposed at locations of the merchant 102. With that said, the number of the components illustrated in the system 100 herein is intended to facilitate clear description and not to limit the scope of the present disclosure.

It should also be appreciated that upon selecting one or more of the products 112a-d for purchase, the consumer 114 may interact with the merchant 102 to transact for the purchased product(s). In connection therewith, to facilitate the transaction in the illustrated embodiment, the consumer 114 is associated with a payment account, issued to the consumer 114 by the issuer 108, which is used to fund the transaction (as described next).

In an exemplary transaction, the consumer 114, after selecting and presenting the product 112a for purchase, for example, presents a payment device associated with the payment account (e.g., a credit card, a debit card, a fob, a smartcard, a virtual application (included in communication device 118, etc.), etc.) to the merchant 102. In turn, the merchant 102 generates an authorization request for the transaction (e.g., including a payment account number and an amount of the purchase, etc.) and communicates the authorization request to the acquirer 104. The authorization request is transmitted generally along path A in the system 100, as shown in FIG. 1. The acquirer 104 communicates the authorization request with the issuer 108 through the payment network 106, such as, for example, through MasterCard®, VISA®, Discover®, American Express®, etc., to determine whether the payment account is in good standing and whether there is sufficient funds and/or credit to cover the transaction. If the transaction is approved, an authorization reply (indicating the approval of the transaction) is transmitted back from the issuer 108 to the merchant 102, along path A, thereby permitting the merchant 102 to complete the transaction. The transaction is later cleared and/or settled by and between the merchant 102, the acquirer 104, and the issuer 108. If declined, however, the authorization reply (indicating a decline of the transaction) is provided back to the merchant 102, along the path A, thereby permitting the merchant 102 to end the transaction or request alternative forms of payment.

Transaction data is generated, collected, and stored as part of the above exemplary interactions among the merchant 102, the acquirer 104, the payment network 106, the issuer 108, and the consumer 114. The transaction data includes a plurality of transaction records, one for each transaction, or attempted transaction. The transaction records, in this exemplary embodiment, are stored at least by the payment network 106 (e.g., in a data structure associated with the payment network 106, etc.). Additionally, or alternatively, the merchant 102, the acquirer 104, and/or the issuer 108 may store the transaction records in corresponding data structures, or transaction records may be transmitted between parts of system 100. The transaction records may include, for example, payment account numbers, amounts of the transactions, merchant IDs, and dates/times of the transactions. It should be appreciated that more or less information related to transactions, as part of either authorization or clearing and/or settling, may be included in transaction records and stored (and/or transmitted) within the system 100, at (or by) the merchant 102, the acquirer 104, the payment network 106 and/or the issuer 108.

In the embodiments herein, consumers (e.g., consumer 114, etc.) involved in the different transactions and/or interactions are prompted to agree to legal terms associated with their payment accounts and/or network-based applications, for example, during enrollment in their accounts and/or installation of such applications, etc. In so doing, the consumers voluntarily agree, for example, to allow merchants, issuers, payment networks, etc., to use transaction and/or location data generated and/or collected during enrollment, or later, and/or in connection with processing transactions, for subsequent use in general, and as described herein.

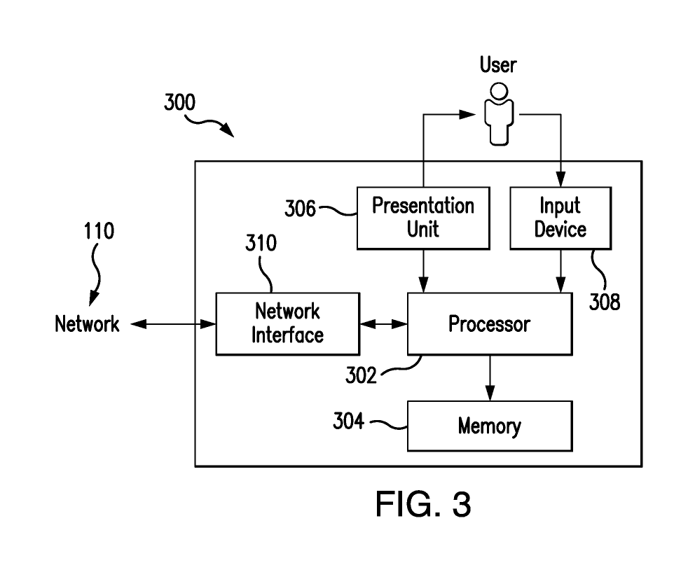

FIG. 3 illustrates an exemplary computing device 300 that can be used in the system 100. The computing device 300 may include, for example, one or more servers, workstations, routers, personal computers, tablets, laptops, smartphones, PDAs, point of sale (POS) devices, etc. In addition, the computing device 300 may include a single computing device, or it may include multiple computing devices located in close proximity or distributed over a geographic region, so long as the computing devices are specifically configured to function as described herein.

In the exemplary system 100 of FIG. 1, each of the merchant 102, the acquirer 104, the payment network 106, and the issuer 108 are illustrated as including, or being implemented in, computing device 300, coupled to (and in communication with) the network 110. In addition, the communication device 118 associated with the consumer 114 and the cameras 116a-d associated with the merchant 102 (as well as the camera 216, and the cameras 516a-c) can also each be considered a computing device (potentially coupled to and in communication with the network 110) consistent with computing device 300 for purposes of the description herein. However, the system 100 should not be considered to be limited to the computing device 300, as described below, as different computing devices and/or arrangements of computing devices may be used. In addition, different components and/or arrangements of components may be used in other computing devices.

As shown in FIG. 3, the exemplary computing device 300 includes a processor 302 and a memory 304 coupled to (and in communication with) the processor 302. The processor 302 may include one or more processing units (e.g., in a multi-core configuration, etc.). For example, the processor 302 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 304, as described herein, is one or more devices that permit data, instructions, etc., to be stored therein and retrieved therefrom. The memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 304 may be configured to store, without limitation, a variety of data structures, product records, consumer location records, image records, intensity thresholds, and/or other types of data suitable for use as described herein. Furthermore, in various embodiments, computer-executable instructions may be stored in the memory 304 for execution by the processor 302 to cause the processor 302 to perform one or more of the functions described herein, such that the memory 304 is a physical, tangible, and non-transitory computer readable storage media. Such instructions often improve the efficiencies and/or performance of the processor 302 that is performing one or more of the various operations herein. It should be appreciated that the memory 304 may include a variety of different memories, each implemented in one or more of the functions or processes described herein.

In the exemplary embodiment, the computing device 300 includes a presentation unit 306 that is coupled to (and is in communication with) the processor 302 (however, it should be appreciated that the computing device 300 could include output devices other than the presentation unit 306, etc.). The presentation unit 306 outputs information, either visually or audibly to a user of the computing device 300, such as, for example, to the consumer 114 at the communication device 118 (e.g., product incentives, product offers, etc.), to a user associated with the merchant 102 (e.g., image data from cameras 116a-d, etc.), etc. It should be further appreciated that various interfaces (e.g., as defined by network-based applications, etc.) may be displayed at computing device 300, and in particular at presentation unit 306, to display, for example, an offer for the consumer 114, etc. The presentation unit 306 may include, without limitation, a liquid crystal display (LCD), a light-emitting diode (LED) display, an organic LED (OLED) display, an “electronic ink” display, speakers, etc. In some embodiments, presentation unit 306 includes multiple devices.

The computing device 300 also includes an input device 308 that receives inputs from the user (i.e., user inputs) such as, for example, selection of an offer for redemption from the consumer 114, etc., or otherwise (e.g., image inputs of the consumer 114 via the cameras 116a-d, etc.). The input device 308 is coupled to (and is in communication with) the processor 302 and may include, for example, a keyboard, a pointing device, a mouse, a button, a stylus, a touch sensitive panel (e.g., a touch pad or a touch screen, etc.), another computing device, a camera, and/or an audio input device. Further, in various exemplary embodiments, a touch screen, such as that included in a tablet, a smartphone, or similar device, behaves as both a presentation unit and an input device.

In addition, the illustrated computing device 300 also includes a network interface 310 coupled to (and in communication with) the processor 302 and the memory 304. The network interface 310 may include, without limitation, a wired network adapter, a wireless network adapter, a mobile network adapter, a GPS transmitter, a GPS receiver, combinations thereof (e.g., a GPS transceiver, etc.), or other device capable of communicating to/with one or more different networks, including the network 110. Further, in some exemplary embodiments, the computing device 300 includes the processor 302 and one or more network interfaces 310 incorporated into or with the processor 302.

Referring again to FIG. 1, the evaluation engine 120 of the system 100 is specifically configured, often by computer-executable instructions, to perform one or more of the operations described herein. In the exemplary embodiment, the evaluation engine 120 is provided at the standalone computing device 300 at the merchant 102, and is generally dedicated to the operations described herein. It should be appreciated, however, that the evaluation engine 120 may be incorporated within one or more other computing devices and/or computing operations at the merchant 102. For example, the evaluation engine 120 may be incorporated into a server computing device, which also hosts advertising, marketing, financial, and/or security operations associated with the merchant 102, or not. Further, in certain other embodiments, the evaluation engine 120 may be incorporated into computing devices apart or remote from the merchant 102 (e.g., with the evaluation engine 120 located external of the merchant 102 (e.g., as a standalone part of the system 100, as part of the payment network 106, etc.), etc.).

The system 100 also includes multiple data structures 122-126. As shown, the data structures 122-126 are associated with the merchant 102 and coupled to the evaluation engine 120. It should be appreciated that the data structures 122-126 may be separate from the evaluation engine 120, as shown, or incorporated therein. Further, in various embodiments, one or more of the data structures 122-126 may be separate from the merchant 102, with the evaluation engine 120 then having access thereto (e.g., via network 110, etc.).

The data structure 122 is a product data structure, which includes product records for various products, including products 112a-d, at the merchant 102. Each product record includes a location, represented by XY coordinates within the merchant location (e.g., based on a coordinate system or grid system defined by the merchant 102 at the merchant location, etc.), and a unique product code (or UPC) or other indicator of the corresponding ones of the products 112a-d, which is at least partially unique to the product. As such, in this embodiment, each product record is expressed as, for example {XY, UPC}. However, in other embodiments, product records may include further and/or other information about the corresponding products 112a-d, the merchant 102, and/or the particular location of the products 112a-d in the merchant 102 (e.g., price, latitude and longitude coordinates, etc.).

The data structure 124 is an image data structure, which is configured to store image records from the cameras 116a-d. As described above, the image records may include raw image data received from the cameras 116a-d, including time stamps, whereupon the evaluation engine 120 may then provide analysis upon receipt. Or, the image records may further include expression intensities (of the consumers whose images have been captured) and locations, based on the cameras 116a-d performing an analysis on the images captured thereby. In such examples, the image records, received from the cameras 116a-d, may include, for each record, the location of the captured image (e.g., the location of the one or more of the cameras 116a-d that captured the image, etc.), the time captured, and an intensity of an expression of a consumer in the captured image, together provided in the form {XY, t, EI}, where XY is again the location, t is the time, and EI is the expression intensity (e.g., likeness-surprise intensity (LS), etc.).

Finally, the data structure 126 is a consumer location data structure, which is configured to store consumer location records, which are received as described below (e.g., based on location records of communication devices associated with the consumers at the merchant 102, etc.). The consumer location records are generally in the form of {XY, t, MAC}, where, for each record, XY is again a location, t is a time, and MAC is an address/identifier associated with the particular communication device associated with a consumer (e.g., communication device 118, etc.) (e.g., a MAC address, etc.). It should be appreciated that the consumers may register to the evaluation engine 120, whereby the MAC addresses (or potentially APP IDs or other identifiers) for the consumers' communication devices are registered to the evaluation engine 120, and stored in the data structure 126, to thereby enable the evaluation engine 120 to operate as described herein.

In operation in the system 100, the evaluation engine 120 is configured to interact with the communication device 118, when the consumer 114 enters and/or moves through the merchant 102 (broadly, during a shopping session by the consumer 114). In doing so, the evaluation engine 120 is configured to receive an identifier associated with the communication device 118 (e.g., a MAC address, APP ID, etc.), and to track the location of the communication device 118 within the merchant 102, in general or at various times (and potentially to store the data in the data structure 126). The evaluation engine 120 is also coupled to (and is in communication with) the cameras 116a-d and configured to receive image records from the cameras 116a-d (and potentially to store the records in the data structure 124). As previously described, the cameras 116a-d are assigned to specific locations in the merchant 102. In connection therewith, the image records provided by each of the cameras 116a-d identify the specific locations of the particular ones of the cameras 116a-d providing the records. In connection therewith, the evaluation engine 120 is configured to merge the received image records from the cameras 116a-d with the consumer location records, based on the location(s) of the communication device 118 during the shopping session for the consumer 114 and product records for the products 112a-d at the merchant 102 (from the data structure 122), to thereby identify the received image records to the communication device 118 and to particular ones of the products 112a-d for which the consumer 114 was in the vicinity. Further, upon receiving the image records, the evaluation engine 120 is configured (or, alternatively, prior to transmitting the image records, the cameras 116a-d are configured to) determine an emotional intensity of the consumer 114, and in particular of the consumer's facial expressions, in connection with the various products being viewed by the consumer 114. In turn, the evaluation engine 120 is configured to select an offer for the consumer 114, based on intensity of the facial expressions of the consumer 114 in the various images when in the vicinity of one or more of the various products 112a-d, and to transmit the offer to the consumer 114 at the communication device 118 (e.g., while the consumer is still at the merchant 102, later, etc.).

It should be appreciated that the evaluation engine 120 may be further configured to compile one or more models, either specific to the consumer 114 or specific to one of the products 112a-d, or more generically (e.g., to a demographic including the consumer 114, etc.). The model(s) may then be transmitted, by the evaluation engine 120, to the merchant 102 and/or other entities associated with the products 112a-d (e.g., competitors, manufacturers, product researchers, etc.), for example, for use in modifying products, product offers, etc.

As described herein, the evaluation engine 120 (and/or the cameras 116a-d) is (are) configured to determine an emotional intensity of the consumer 114, and in particular of the consumer's facial expression(s), based on the image record(s) associated therewith. In so doing, the evaluation engine 120 (and/or the cameras 116a-d) may be configured to use/apply any suitable operations or methodologies to determine the emotional intensity including, for example, one or more of those described in the following references, which are incorporated herein by reference in their entirety: “Identifying Emotional Expressions, Intensities and Sentence level Emotion Tags using a Supervised Framework,” Dipankar Das and Sivaji Bandyopadhyay, Department of Computer Science and Engineering, Jadavpur University, PACLIC 24 Proceedings (2010), pages 95-104; and “Measuring the intensity of spontaneous facial action units with dynamic Bayesian network,” Yongqiang Li et al., Pattern Recognition 48 (2015) 3417-3427.

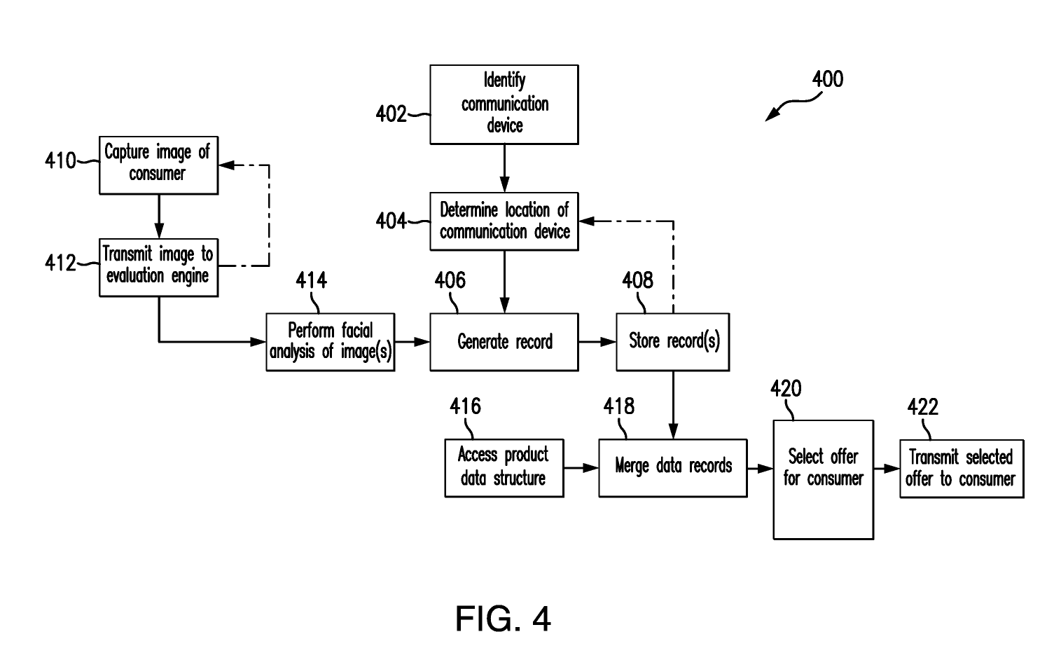

FIG. 4 illustrates an exemplary method 400 for use in determining interest of a consumer in a product based on intensities of facial expressions of the consumer for one or more emotional factors. The method 400 is described herein with reference to the system 100, and in particular, as operations of the portable communication device 118 and the evaluation engine 120. It should be appreciated, however, that the methods described herein are not limited to the system 100. And, conversely, it should be appreciated that the systems described herein are not limited to the exemplary method 400.

In the method 400, the consumer 114 initiates a shopping session by entering the location of the merchant 102 along with the communication device 118 and beginning to shop for products, including products 112a-d. As the consumer moves through the location of the merchant 102, the consumer 114 comes within the vicinity of one or more of the products 112a-d, occasionally.

At 402 in the method 400, the evaluation engine 120 initially identifies the communication device 118. The evaluation engine 120 may identify the communication device 118 based on, for example, a MAC address associated with the communication device 118, or an interaction with a network-based application installed and active on the communication device 118 (e.g., via an APP ID, etc.). In at least one embodiment, the consumer 114 may activate the network-based application, at the communication device 118 (e.g., manually, automatically, etc.), to signal to the evaluation engine 120 that the consumer 114 is at the merchant location. In connection therewith, and as described above, the consumer 114 may be registered to the evaluation engine 120, whereby the MAC address (or the APP ID or other identifier) is registered to the evaluation engine 120 (and stored in the data structure 122) to thereby enable the evaluation engine 120 to identify the communication device 118 and/or communicate therewith. Either by registering, or through some other method, the consumer 114 consents to the tracking of their communication device 118 and to the capture of their facial expression for analysis as described in the present disclosure.

Once identified, the evaluation engine 120 cooperates with the communication device 118 to determine, at 404, the location of the communication device 118 at the merchant location. The evaluation engine 120 may determine the location at multiple different times, or continuously track the location of the communication device 118 as the consumer 114 moves about the merchant location. In so doing, the evaluation engine 120 may determine the location of the communication device 118 based on GPS data received from the communication device 118 and/or based on router data revived from the communication device 118, and/or based on one or more other interactions with the communication device 118, as described above. Then, when the location is determined, the evaluation engine 120 generates a consumer location record, at 406, and stores the record in the data structure 126, at 408. Here, the consumer location record includes the location of the communication device 118 at the merchant 102, or XY coordinate, the time (t) at which the communication device 118 is at the location, and the MAC address associated with the communication device 118, thereby providing a consumer location record in the format: {XY, t, MAC}. As indicated by the dotted line in FIG. 4, the evaluation engine 120 repeats operations 404-408 as the consumer 114 (and the communication device 118) moves through the merchant location, during the shopping session (continuously, periodically, etc.). As such, multiple consumer location records are generated, at 406, and stored, at 408. It should be appreciated that consumer location records for the communication device 118, or for other devices, may be expressed in various other formats (e.g., other than {XY, t, MAC}, comprising other combinations of data (other than XY, t, and MAC), etc.), yet still be consistent with the description herein.

With continued reference to FIG. 4, separately in the method 400, as the consumer 114 continues to move at the merchant location, the consumer 114 may stop in front of the product 112b, for example, to examine the product 112b and potentially pick it up (depending on the product 112b, its packaging, etc.). In response, the camera 116b captures, at 410, an image of the consumer 114, and in particular, the consumer's face. The captured image is time stamped with the date and/or time of the captured image. The camera 116b then transmits, at 412, the image to the evaluation engine 120. Operations 410-412 may be repeated each time the consumer 112 stops at (or is in the vicinity of) one of the products 112a-d and/or one of the cameras 116a-d.

Upon receipt of the image(s) (and upon identifying the particular product in which the consumer 114 is interested, or prior thereto as in the illustrated method 400), the evaluation engine 120 performs one or more facial analysis operations on the image(s), at 414. Specifically, for example, the evaluation engine 120 determines an emotional intensity from the image(s). In so doing, the evaluation engine 120 may initially determine, for each of various different emotional dimensions for the consumer 114, a level of intensity of the consumer in connection with a particular product being viewed (e.g., on a scale of one to ten for each emotional dimension, with one representing a weakest value of the particular emotional dimension and ten representing a strongest value of the particular emotional dimension; on another scale; etc.). Then, the intensity levels for each of the different emotional dimensions may be combined (e.g., summed, averaged, etc.) and compared to a threshold to make an inference, for example, regarding the consumer's probable inner thoughts about the product being viewed. Such emotional dimensions may include, without limitation, likeness, surprise, confusion, focus, exhaustion, sadness, interest, happiness, amazement, openness, understanding, anger etc. And, a level of intensity of such emotional dimensions may be determined (e.g., on the scale of one to ten, etc.) based on various facial characteristics known to be associated with the particular emotional dimensions.

In one implementation, the facial analysis, by the evaluation engine 120, may be specific to the likeness (e.g., as generally indicated by crow's feet wrinkles, raised cheeks, etc.) and surprise (e.g., as generally indicated by raised eyebrows, widened eyes, open mount, etc.) emotion factors of facial expression (thereby generating a likeness-surprise (LS) emotional intensity). That is, the intensity is generally indicative of a positive facial expression. Here, for example, LS emotional intensity from a scale of −k to +k can be evaluated at individual levels (e.g., for the consumer 114, for other consumers, etc.) for the likeness and surprise emotion factors based on historical facial responses. As can be appreciated, LS emotional intensity can be a complex function of shape and relaxing of facial muscles, mouth shape, eye shape, and so on (e.g., taking into account the various facial features identified above, taking into account other facial features or combinations of facial features, etc.). Thus, from the recorded historical shapes, the evaluation engine 120 can determine a normal facial expression for the consumer 114 (e.g., resulting in an LS score of 0, etc.). Then, facial expressions by the consumer consistent with the likeness and surprise factors (suggesting a positive purchase) will have a relatively high, positive LS score on the scale of −k to +k (based on the particular scale used to represent the LS score). While facial expressions by the consumer inconsistent with the likeness and surprise factors will have a relatively low, negative LS score on the scale of −k to +k.

It should be appreciated that while the evaluation engine 120 performs the facial analysis in the method 400 to determine the intensity of the facial expression of the consumer 114, as to one or more emotional factors, the cameras 116a-d, or ones of the cameras 116a-d, may be employed to perform the analysis in other embodiments in one or more of the manners described above. In such embodiments, the camera 116b, for example, transmits, at 412, image data (broadly, an image record) to the evaluation engine 120, which includes an intensity of the facial expression and a time of the captured image, etc. The image data may additionally, or optionally, include a location of the camera 116b (or a location of the camera's view) and the raw image captured by the camera 116b, etc.

In either case, once the intensity of the facial expression is determined (whether at the evaluation engine 120, at the camera 116b, or elsewhere), the evaluation engine 120 generates an image record for the image, at 406, and stores the image record to the image data structure 124, at 408. Generating the image record may simply include arranging image data consistent with the format included in the image data structure 124, or other operations may be performed. In the method 400, for example, generating the image record may include arranging the image data in the format: {XY, t, LS }, where XY is the location within the merchant 102 at which the image is captured, t is the time (and/or date) the image is captured, and LS is the likeness-surprise emotional intensity. It should be appreciated that image records may be expressed in various other formats (e.g., other than { XY, t, LS}, comprising other combinations of data (other than XY, t, and LS), etc.), yet still be consistent with the description herein.

It should also be appreciated that, in the method 400, the cameras 116a-d are disposed in substantially fixed locations in the merchant 102 (although this is not required in all embodiments). As such, when the image is received by the evaluation engine 120 from the camera 116b, the evaluation engine 120 understands that the image is associated with a specific location at the merchant 102. The location may, therefore, be stored with the image record (at 408) and/or maintained in a separate data structure, which is accessible to the evaluation engine 120. In one or more other embodiments, the camera 116b and/or the evaluation engine 120 may determine the location of the camera 116b, for example, at the time that the image is captured and append the location to the image and to the image record (when generating the image record at 406, for example). Similar to the communication device 118, the location of the cameras 116a-d may be determined based on an XY coordinate system of the merchant 102, GPS data, router data, etc., as described above.

Next in the method 400, the evaluation engine 120 accesses, at 416, the product data structure 122, which includes product records for the product 112b (as well as for multiple other products). In the method 400, the product records are in the format: {XY, UPC}, where XY is the location of the particular product at the merchant 102 and UPC is the unique product code for the product. The product data structure 122 (or records therein) may further include an indication of the particular camera for (or associated with) each of the products. It should be appreciated that product records may be expressed in various other formats (e.g., other than {XY, UPC}, comprising other combinations of data (other than XY and UPC), etc.), yet still be consistent with the description herein.

Then, the evaluation engine 120 merges, at 418, the determined consumer location records and image records (from 408), and the product records (from 416), based on at least time and location. Specifically, for example, the evaluation engine 120 may merge the records based on time and location being within respective thresholds (e.g., based on time in the records being within 3 seconds, 5 second, 10 seconds, etc. of each other; based on location in the records being within the same zone in a grid, being no more than one zone apart, being no more than five zones apart, etc.; combinations thereof; etc.). In turn, based on the captured images from the different cameras 116a-d and the location records associated with the consumer 114 at the time the images are captured, as included in the merged records, the evaluation engine 120 can identify a particular one of the products 112a-d on which the consumer 114 is focused (e.g., based on a direction the consumer 114 is moving, a direction the consumer 114 is facing, an angle of the consumer's head, etc.). In connection therewith, the merged records may have a format: {MAC, t, UPC, LS}, thereby linking the intensity of facial expressions determined from the captured images (e.g., the likeness-surprise intensities, etc.) to the product(s) and the consumer 114 (via the communication device 118) in the vicinity of the product(s).

Once the records are merged, the evaluation engine 120 selects, at 420, at least one offer to be provided to the consumer 114 based on the merged records. The selection, by the evaluation engine 120, may include an offer corresponding to a product (by UPC) at the merchant 102 for which the consumer, when in the vicinity of the product, expressed a particular likeness-surprise intensity during the shopping session (e.g., a highest likeness-surprise intensity, a median likeness-surprise intensity, etc.). Additionally, or alternatively, the evaluation engine 120 may select the offer when the intensity in one or more merged records exceeds a predefined threshold.

The evaluation engine 120 generally selects the offer during the current shopping session for the consumer 114, to thereby encourage the consumer 114 to purchase a product (e.g., one of the products 112a-d, etc.) in which the consumer 114 has interest (or appears to have expressed interest). It should be appreciated that selection may be based on the merged records for the current shopping session, and further on one or more prior shopping sessions, whereby the selection by the evaluation engine 120 accounts for interest over time (i.e., not only in the current shopping session but in prior shopping sessions as well). For example, the consumer 114 may linger at product 112c in multiple different shopping sessions, where the intensity of the facial expressions for the consumer 114 is always just below a threshold for selecting an offer. Based on the consumer 114 repeating this behavior in multiple shopping sessions, the evaluation engine 120 may detected the duplicate merged records for the product 112c and adjust the threshold and/or select an offer for the product. As another example, the evaluation engine 120 may identify that multiple different consumers continually linger at product 112c. As such, when the consumer 114 is also identified as lingering at the product 112c, but the intensity of his/her facial expressions is just below a threshold for selecting an offer, the evaluation engine 120 may adjust the threshold or select an offer, for the consumer 114, based on/taking into account the common interest among the multiple consumers (including the consumer 114).

With that said, the offer selected by the evaluation engine 120 (at 420) may include any desired offer such as, for example, a coupon for a percentage off the purchase price of a particular product, a rebate for a particular product, or any other offer to reduce the price of a product, reduce the price of related products (or competing products), or otherwise encourage the consumer 114 to purchase a particular product or like product. Further, in some embodiments, the offer may be based on a value of the intensity, determined by the evaluation engine 120 (where different offers may be available to the consumer 114 when the intensity exceeds a predefined threshold, based on an amount by which the threshold is exceeded).

In some implementations of the method 400, the offer selection, by the evaluation engine 120, may be based on the merged records in combination with historical transaction data (e.g., transaction data for one or more payment accounts, etc.), consumer demographics (e.g., age, gender, location, etc.), etc. Here, the transaction data may be compiled as described above with reference to FIG. 1 for the payment account associated with the consumer 114, for example, or for other consumers.

Finally in the method 400, once an offer is selected, the evaluation engine 120 transmits, at 422, the offer to the consumer 114, and specifically, to the communication device 118. The evaluation engine 120 may transmit the offer via short-message service (SMS), e-mail, and/or to a network-based application in the communication device 118, any of which may result in a visual and/or audible notification to the consumer 114. In response, the consumer 114, if interested in the product 112b, for example (as indicated by the intensity of the facial expression), is further encouraged to purchase the product 112b from the merchant 102.

In another aspect of the present disclosure, the evaluation engine 120 may further be able to compile the merged records (e.g., from 418 in the method 400, etc.), which include intensity of facial expressions and product identifiers (with or without the communication device identifiers). The merged records may be provided to one or more entities, including, for example, the merchant 102, to provide feedback as to interest in the products by the consumers, including the consumer 114. Based on such feedback, the entities can alter products, product offers, etc., as appropriate to potentially improve salability of the products.

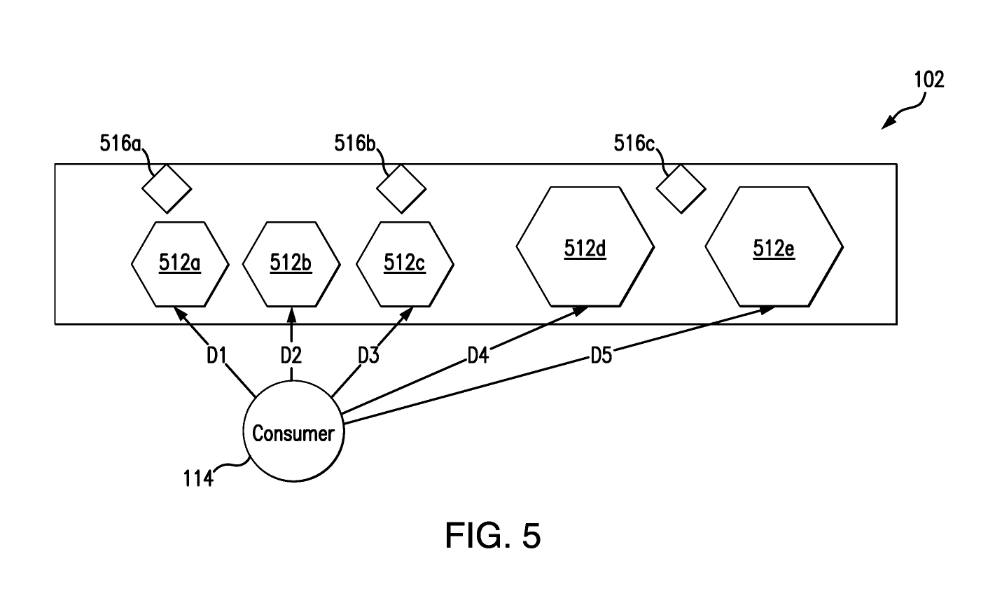

FIG. 5 schematically illustrates an example grouping/installation of cameras 516a-c that may be employed in the method 400 (and/or in the system 100) to capture images of the consumer 114 at the merchant 102, when the consumer 114 is in the vicinity of products 512a-e at the merchant 102. The grouping/installation of the cameras 516a-c may be within a single product display at the merchant 102 (with the single product display comprising the products 512a-e), or the grouping/installation may be within an isle or other common location of the merchant 102 (potentially having multiple product displays for the different products 512a-e).

In particular in this example, as the consumer 114 moves through the merchant 102 (as the consumer initiates a shopping session), consumer location records are generated for the consumer 114 with the consumer's consent. In connection therewith, Table 1 illustrates multiple exemplary consumer location records that may be generated for the consumer 114 and stored in the data structure 126, during the shopping session by the consumer 114 at the merchant 102. In this example, each consumer location record is in the format: {XY, t, MAC}, where XY is representative of a grid system associated with the merchant 102, t is representative of a time at which the consumer 114 is at the corresponding location, and MAC is representative of the consumer's communication device 118.

TABLE 1

| Record Number | {XY, t, MAC} |
|---|---|
| 1 | {(10, 32), 13:24:26, 01-23-45-67-89-ab} |
| 2 | {(11, 32), 13:24:54, 01-23-45-67-89-ab} |
| 3 | {(11, 32), 13:25:12, 01-23-45-67-89-ab} |
| 4 | {(11, 32), 13:25:41, 01-23-45-67-89-ab} |
| 5 | {(15, 32), 13:26:01, 01-23-45-67-89-ab} |
| 6 | {(17, 40), 13:26:38, 01-23-45-67-89-ab} |
| . . . | . . . |

The cameras 516a-c may be pre-installed in the merchant 102 at specific locations and facing specific directions. For instance, in this example, the cameras 516a-c may be located in the merchant 102 as indicated in Table 2. And, when the consumer 114 is within view of the cameras 516a-c (with the cameras 516a-c continually collecting data, for example), the cameras 516a-c each capture an image (or multiple images) of the consumer 114 and transmit the image(s) to the evaluation engine 120.

TABLE 2

| Camera | Camera ID | X | Y | Direction | Time (t) |
|---|---|---|---|---|---|
| 516a | 1036 | 10 | 36 | −90 | 13:24:54 |
| 516b | 1236 | 12 | 36 | −90 | 13:24:54 |
| 516c | 1436 | 15 | 36 | −90 | 13:24:54 |

In turn, the evaluation engine 120 analyzes the received image(s) to determine an emotional intensity of the consumer 114 in the image(s) (if not done by the cameras 516a-c). In this example, the analysis is specific to a likeness-surprise (LS) emotional intensity, and includes evaluation of the image(s) relative to a likeness emotional factor (e.g., as generally indicated by crow's feet wrinkles, raised cheeks, etc.) and a surprise emotional factor (e.g., as generally indicated by raised eyebrows, widened eyes, open mount, etc.). In particular, based on the facial expression(s) of the consumer 114 in the received image(s), the evaluation engine 120 rates the consumer 114 on a scale of 1-10 for each factor, taking into account the general facial features known to indicate each factor. The evaluation engine 120 then combines the ratings (e.g., sums the ratings in this example, etc.) to determine the LS emotional intensity for the consumer 114.

The evaluation engine 120 next generates an image record for the image (or for each of the images) received and analyzed. Table 3 illustrates multiple exemplary image records (stored in the data structure 124), as generated during the shopping session by the consumer 114 at the merchant 102. In this example, each image record is in the format: {XY, t, LS }. Also in this example, a normal LS emotional intensity score has been shifted to LS=10, on a scale of 0-20.

TABLE 3

| Record Number | {XY, t, LS} |
|---|---|
| 1 | {(10, 36), 13:24:32, 8} |
| 2 | {(10, 36), 13:24:51, 14} |
| 3 | {(12, 36), 13:25:15, 15} |
| 4 | {(12, 36), 13:25:38, 16} |
| 5 | {(15, 36), 13:26:03, 5} |
| . . . | . . . |

In addition in this example, the products 512a-e are located in the merchant 102 at specific positions. In particular, the products 512a-e may be positioned in the merchant 102 at the specific locations indicated in Table 4. In connection therewith, each product may be associated with a product record, as shown in Table 5, which is stored in the data structure 122. In this example, each of the product records is in the format: {XY, UPC}, where XY is the location of the particular product at the merchant 102, and UPC is the unique product code for the product.

TABLE 4

| Product | Product ID | X | Y | UPC |
|---|---|---|---|---|
| 512a | 15 | 10 | 35 | 123 |
| 512b | 15 | 11 | 35 | 124 |
| 512c | 15 | 12 | 35 | 125 |
| 512d | 6 | 14 | 35 | 42 |
| 516e | 6 | 16 | 35 | 43 |

TABLE 5

| Record Number | {XY, UPC} |
|---|---|
| 1 | {(10, 35), 123} |
| 2 | {(11, 35), 124} |
| 3 | {(12, 35), 125} |
| 4 | {(14, 35), 42} |
| 5 | {(16, 35), 43} |

Then in this example, the evaluation engine 120 merges the various consumer location records, the image records, and the product records based on time and location. Specifically, for example, the evaluation engine 120 merges the records based on time records being within ten seconds of each other, and location records being within plus/minus five zones of the same XY grid zone. Table 6 illustrates the merged records, for the example records presented in Tables 1, 3, and 5, in the format: {MAC, t, UPC, LS}. The merged records thereby link the intensity of the consumer's facial expressions, as determined from the captured images at the cameras 516a-c, to the various product(s) that were viewed by the consumer 114 and the consumer 114 himself/herself (via the communication device 118), when the consumer 114 is in the vicinity of the product(s).

TABLE 6

| Record Number | {MAC, t, UPC, LS} |
|---|---|
| 1 | {01-23-45-67-89-ab, 13:24:26, 123, 8} |
| 2 | {01-23-45-67-89-ab, 13:24:54, 124, 14} |
| 3 | {01-23-45-67-89-ab, 13:25:12, 124, 15} |
| 4 | {01-23-45-67-89-ab, 13:25:41, 124, 16} |
| 5 | {01-23-45-67-89-ab, 13:26:01, 43, 5} |
| . . . | . . . |

Based on the above, in general, when the consumer 114 is located in the merchant 102 at XY=(11, 32) (as illustrated in FIG. 5), the evaluation engine 120 can determine a particular product being viewed by the consumer 114. For instance, based on a shortest distance match from the position of the consumer 114 to the various products 512a-e in the merchant 102 (e.g., based on distances D1-D5, etc.), the evaluation engine 120 can determine that the closest ones of the products 512a-e are products 512a-c (with UPCs=123, 124, and 125). In addition, based on a shortest distance match from the consumer 114 to the various cameras 516a-c, the closest are cameras 516a, 516b (with camera IDs 1036 and 1236), facing in a direction of −90 degrees so as to be capable of capturing images of the consumer 114. In turn, from the relative angle between the consumer 114 and the cameras 516a, 516b, the evaluation engine 120 can determine that the consumer 114 is looking at product 512b (e.g., taking into account a direction the consumer 114 is moving, a direction the consumer 114 is facing, an angle of the consumer's head, etc.).

Finally in this example, the evaluation engine 120 selects at least one offer to be provided to the consumer 114 based on the merged records (e.g., as shown in Table 6, etc.). The selection, by the evaluation engine 120, may include an offer corresponding to a product (by UPC) at the merchant 102 for which the consumer 114, when in the vicinity of the product, expressed a particular likeness-surprise intensity during the shopping session (e.g., a highest likeness-surprise intensity, a median likeness-surprise intensity, etc.). For example, with reference to the merged records in Table 6, and based on a predefined threshold of 12 (which, for example, may be empirically determined as a sufficient level of LS intensity), the evaluation engine 120 may identify an offer for the product with the UPC 124, and provide the offer to the consumer 114 (via the communication device 118, etc.). As another example, again with reference to the merged records in Table 6, and based on predefined thresholds of 8 and 12, the evaluation engine may identify one offer for the product with the UPC 123 and another offer for the product with the UPC 124 (and provide the offers to the consumer 114 via his/her communication device 118, etc.). In other examples, the offer engine may further take into account merchant inventory and cost in determining which offers, if any, to provide to the consumer 114.

In view of the above, the systems and methods herein permit reactions of consumers, as determined from facial expressions, to provide indications of the consumers' like and/or dislike of products offered for sale by merchants. While written and/or verbal consumer feedback (i.e., active feedback) in various forms is often available and useful, for the merchants, to determine what products to continue selling, or not, the facial expressions of consumers, as addressed herein, in the presence and/or vicinity of products, provides an unbiased, pure passive feedback mechanism, which alone, or in combine with other feedback, may provide a more accurate and efficient indication of the consumers' response, thoughts and/or feelings about the products. The methods and systems herein therefore may be able to provide a passive feedback mechanism, which avoids consumer overthinking and/or bias in connection with active feedback.

It should be appreciated that the functions described herein, in some embodiments, may be described in computer executable instructions stored on a computer readable media, and executable by one or more processors. The computer readable media is a non-transitory computer readable media. By way of example, and not limitation, such computer-readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

The systems, devices, and methods described herein may be partially or fully implemented by a special purpose computer created by configuring a general purpose computer to execute one or more particular functions embodied in computer executable instructions. In addition, the functional blocks and flowchart elements described above serve as software specifications, which can be translated into the computer executable instructions by the routine work of a skilled technician or programmer.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) capturing an image of a consumer when the consumer is in the vicinity of a product at a merchant, the image depicting a facial expression of the consumer; (b) determining an intensity associated with the facial expression of the consumer, as captured in the image; (c) determining a location at the merchant of a communication device associated with the consumer; (d) selecting an offer associated with the product for the consumer, based on the intensity of the facial expression and the determined location of the communication device, thereby relying at least in part on a consumer reaction to select the offer; (e) merging an intensity record associated with the intensity of the facial expression of the consumer and a consumer location record indicative of the location at the merchant of the communication device associated with the consumer; (f) identifying a product record associated with the identified location; and (g) transmitting the offer to the communication device, thereby permitting the consumer to redeem the offer.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service, or further summaries, depictions, descriptions, or other data pertaining to the good and/or service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements/features recited in the claims are intended to be a means-plus-function element within the meaning of 35 U.S.C. § 112(f) unless an element is expressly recited using the phrase “means for,” or in the case of a method claim using the phrases “operation for” or “step for.”

Further, the methods and systems described herein are intended to be carried out in full compliance with all applicable consumer data privacy and data usage laws.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in gaining insight into consumer interest in products, the method comprising:
capturing an image of a consumer when the consumer is in the vicinity of a product at a merchant, the image depicting a facial expression of the consumer;
determining an intensity associated with the facial expression of the consumer, as captured in the image;
determining, by a computing device, a location at the merchant of a communication device associated with the consumer; and
selecting, by the computing device, an offer associated with the product for the consumer, based on the intensity of the facial expression and the determined location of the communication device, thereby relying at least in part on a consumer reaction to select the offer.

2. The computer-implemented method of claim 1, further comprising merging an intensity record associated with the intensity of the facial expression of the consumer and a consumer location record indicative of the location at the merchant of the communication device associated with the consumer; and
wherein selecting the offer includes selecting the offer based on the merged records.

3. The computer-implemented method of claim 2, wherein merging the records includes merging the records based on time and location.

4. The computer-implemented method of claim 2, further comprising identifying a product record associated with the identified location; and
wherein merging the records further includes merging the product record with the intensity record and the consumer location record based on at least location.

5. The computer-implemented method of claim 1, wherein the determined intensity of the facial expression is associated with a likeness and/or surprise-ness factor of the facial expression.

6. The computer-implemented method of claim 5, wherein determining the intensity associated with the facial expression includes determining, at the computing device, the intensity associated with the likeness and/or surprise-ness factor of the facial expression.

7. The computer-implemented method of claim 1, further comprising transmitting the offer to the communication device, thereby permitting the consumer to redeem the offer.

8. The computer-implemented method of claim 1, wherein selecting the offer associated with the product is further based on a historical merged record for the consumer, the historical merged record including an identifier for the communication device and based on a prior shopping session.

9. A system for use in providing offers to consumers, the system comprising:
a memory including a product data structure, the product data structure including multiple product records, each product record including a location of a product at a merchant location and a product identifier of the product; and
at least one processor coupled to the memory and configured to:
determine a location of a communication device at the merchant location;
receive an image record from a camera disposed at the merchant location, the image record indicative of a first location and including a facial expression for a consumer at the first location;
associate an intensity of the facial expression for the image record with a product, based on the determined location of the communication device; and
select and transmit an offer to the consumer, at the communication device, based on the intensity of the facial expression for the product, thereby relying, at least in part, on the facial expression of the consumer to select the offer.

10. The system of claim 9, wherein the at least one processor is configured, in order to associate the intensity with the product, to merge the product record associated with said product with a consumer location record including the determined location of the communication device, and the image record, based on location and/or time; and
wherein the image record includes the intensity of the facial expression.

11. The system of claim 10, wherein the at least one processor is further configured to store the determined location of the communication device in the consumer location record, in a consumer location data structure in the memory, the consumer location record further including a time the communication device as at the determined location and an identifier of the communication device, and
wherein the at least one processor is further configured to store the image record in an image record in the memory.

12. The system of claim 9, wherein the at least one processor is further configured to determine the intensity of the facial express from the image record received from the camera.

13. The system of claim 12, wherein the at least one processor is configured to select the offer for the consumer based on the intensity of the facial expression exceeding a predefined threshold.

14. The system of claim 9, wherein the at least one processor is further configured to access historical transaction data for the consumer and to select the offer based on the historic transaction data for the consumer.

15. The system of claim 9, further comprising the camera, the at least one processor in communication with the camera to receive the image record.

16. A non-transitory computer-readable storage media including executable instructions, which when executed by at least one processor, cause the at least one processor to:
generate an image record for an image, the image record including an intensity of a facial expression in the image;
generate a consumer location record for a communication device;
compile a merged record based on the image record, the consumer location record, and a product record based on time;
select an offer for the consumer based on the merged record; and
transmit the offer to the communication device, such that a consumer associated with the communication device is able to redeem the offer with the merchant.

17. The non-transitory computer-readable storage media of claim 16, wherein the executable instructions, when executed by the at least one processor, cause the at least one processor to generate a consumer location record at least at a plurality of times for the communication device, and determine a location of the communication device at each of the plurality of times, prior to generating each of the consumer location records.

18. The non-transitory computer-readable storage media of claim 17, wherein the merged record includes a product identifier for the product, the intensity of the facial expression and an identifier associated with the communication device.

19. The non-transitory computer-readable storage media of claim 17, wherein the executable instructions, when executed by the at least one processor, cause the at least one processor to receive the image from a camera and to determine the intensity of the facial expression in the image, prior to generating the image record.

20. The non-transitory computer-readable storage media of claim 17, wherein the executable instructions, when executed by the at least one processor, cause the at least one processor to select the offer based on multiple merged records, the merged records associated with a current shopping session and/or at least one prior shopping session
